(19) United States
(12) Patent Application Publication
(10) Pub. No.: US 2024/0119364 A1
(43) Pub. Date: Apr. 11, 2024

(54) AUTOMATICALLY GENERATING AND IMPLEMENTING MACHINE LEARNING MODEL PIPELINES

(71) Applicant: Chime Financial, Inc., San Francisco, CA (US)

(72) Inventors: Akshay Jain, Boise, ID (US); Frank Teoh, Milpitas, CA (US); Peeyush Agarwal, Mountain View, CA (US); Michael Tompkins, San Francisco, CA (US); Sashidhar Guntury, Laguna Niguel, CA (US); Yunfan Zhong, Mountain View, CA (US); Greg Tobkin, San Francisco, CA (US)

(21) Appl. No.: 18/471,845

(22) Filed: Sep. 21, 2023

Related U.S. Application Data
(60) Provisional application No. 63/378,818, filed on Oct. 7, 2022.

(51) Int. Cl. G06N 20/00

(52) U.S. Cl. CPC G06N 20/00

(57) ABSTRACT

The present disclosure relates to systems, non-transitory computer-readable media, and methods for automatically generating and executing machine learning pipelines based on a variety of user selections of various settings, machine learning structures, and other machine learning pipeline criteria. In particular, in one or more embodiments, the disclosed systems utilize user input selecting various machine learning pipeline settings to generate machine learning model pipeline files. Further, the disclosed systems execute and deploy the machine learning pipelines based on user-selected schedules. In some embodiments, the disclosed systems also register the machine learning pipelines and associated machine learning pipeline data in a machine learning pipeline registry. Further, the disclosed systems can generate and provide a machine learning pipeline graphical user interface for monitoring and managing machine learning pipelines.

### CROSS-REFERENCE TO RELATED APPLICATION

This application claims the benefit of and priority to U.S. Provisional Patent Application No. 63/378,818, filed on Oct. 7, 2022. The aforementioned application is hereby incorporated by reference in its entirety.

### BACKGROUND

Recent years have seen significant development in popularity and usage of machine learning models. Indeed, the proliferation of machine learning models has extended into many contexts and use cases. Accordingly, significant development has also been made in generation of machine learning models. Many conventional systems generate machine learning models via many separate processes and steps, including generating an untrained machine learning model, training the machine learning model, evaluating the machine learning model, etc. In many conventional systems, these steps are treated as separate processes and executed via separate computer entities.

In view of the foregoing complexities, conventional machine learning model systems have a number of problems. For example, many conventional machine learning model systems lack accuracy in generating accurate machine learning models. Indeed, generating machine learning models with adequate structure and training procedures to generate accurate output is a particularly inaccurate process in conventional machine learning model systems. To illustrate, conventional machine learning model systems often rely on trial and error to generate machine learning models, requiring many steps across various isolated systems to check machine learning models. Further, conventional machine learning model systems often require testing of each machine learning model to ascertain any potential accuracy of any individual machine learning model.

Additionally, many conventional machine learning model systems lack efficiency. To illustrate, many conventional machine learning model systems isolate various steps in generating and implementing machine learning models. For example, many conventional machine learning model systems require separate generation of an untrained machine learning model, training of the machine learning model, and deployment of the machine learning model. Accordingly, many conventional machine learning model systems require excessive user interaction across a variety of isolated systems to generate and implement a machine learning model.

Further, by isolating these processes, many conventional machine learning model systems expend excessive computational resources such as computing time and processing power in generating and implementing machine learning models. To illustrate, especially in processes or systems utilizing various machine learning models, separately generating and implementing the machine learning models requires excessive computational resources. Indeed, many similar processes are needlessly repeated separately due to isolation of various steps in generating and implementing machine learning models. Further, this inefficiency is compounded by inaccuracies discussed above, requiring repeated generation and testing of machine learning models before a useful model is achieved.

### BRIEF SUMMARY

Embodiments of the present disclosure provide benefits and/or solve one or more of the foregoing or other problems in the art with systems, non-transitory computer-readable media, and methods for generating and implementing a machine learning model pipeline utilizing resources from a machine learning pipeline registry. In particular, the disclosed systems can utilize user input selecting various machine learning pipeline resources to generate machine learning model pipelines accurately and efficiently. To illustrate, the disclosed systems can receive user input indicating a template machine learning model, ground-truth dataset selections, and/or training parameters selections. Accordingly, the disclosed systems can efficiently generate the machine learning pipeline based on these user selections.

More specifically, in one or more embodiments, the disclosed systems generate a machine learning pipeline file based on the user input. Specifically, in one or more embodiments, the disclosed systems generate a machine learning pipeline file for generating, training, and implementing a machine learning model. To illustrate, utilizing the machine learning pipeline file, the disclosed systems prepare ground-truth datasets, generate untrained machine learning models, train machine learning models, and define scheduling infrastructure for the machine learning models. Further, in some embodiments, the machine learning pipeline management system implements machine learning models and store the machine learning pipeline files in a machine learning pipeline registry.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a machine learning pipeline management system can operate in accordance with one or more embodiments.

FIG. 2 illustrates an overview of a process for generating a machine learning pipeline file in accordance with one or more embodiments.

FIG. 3 illustrates an example process for generating and implementing machine learning pipelines in accordance with one or more embodiments.

FIG. 4 illustrates an example process for continuous integration and continuous deployment of machine learning pipeline files in accordance with one or more embodiments.

FIG. 5 illustrates an example process for monitoring machine learning pipelines and identifying errors in accordance with one or more embodiments.

FIG. 6 illustrates a flowchart of a series of acts for generating, implementing, and storing machine learning pipelines in accordance with one or more embodiments.

FIG. 7 illustrates a block diagram of an example computing device for implementing one or more embodiments of the present disclosure.

FIG. 8 illustrates an example environment for an inter-network facilitation system in accordance with one or more embodiments.

### DETAILED DESCRIPTION

This disclosure describes one or more embodiments of a machine learning pipeline management system that generates machine learning pipelines utilizing machine learning pipeline registry resources and implements machine learning pipelines via continuous integration and continuous deployment. Accordingly, the machine learning pipeline management system can accurately and efficiently generate a machine learning pipeline and integrate it into existing processes. In some embodiments, the machine learning pipeline management system evaluates the machine learning pipeline and registers the machine learning pipeline in a machine learning pipeline registry. Further, in one or more embodiments, the machine learning pipeline management system generates and provides a machine learning pipeline graphical user interface for monitoring and managing generated machine learning pipelines.

In some embodiments, the machine learning pipeline management system generates the machine learning pipeline based on user input. To illustrate, the machine learning pipeline management system can receive indication of user input selecting a variety of criteria for a machine learning pipeline. In some embodiments, the machine learning pipeline management system receives and implements user selections for template machine learning models, ground-truth dataset, training parameters, scheduling parameters, and other machine learning pipeline criteria.

More specifically, the machine learning pipeline management system can provide a machine learning pipeline generation graphical user interface. To illustrate, the machine learning pipeline management system generates a unified graphical user interface including selectable options for a variety of machine learning pipeline parameters. Further, the machine learning pipeline management system can provide selectable options for stored machine learning pipeline resources from a machine learning pipeline registry. Accordingly, the machine learning pipeline management system can efficiently generate a machine learning pipeline based on user selection of existing machine learning pipeline assets in a machine learning pipeline generation graphical user interface. Further, the machine learning pipeline management system generation graphical user interface can provide options for selection and/or upload of new assets, which may be used in conjunction with assets from the machine learning pipeline registry.

In some embodiments, based on these various selections, the machine learning pipeline management system generates a file for the machine learning pipeline. The machine learning pipeline management system can automatically generate a machine learning pipeline file (e.g., a docker image file) based on the received user selections. More specifically, in one or more embodiments, the machine learning pipeline management system generates a machine learning pipeline file including instructions for generating an untrained machine learning model based on a template machine learning model, training the machine learning model utilizing selected ground-truth data and training parameters, and deploying the model based on selected scheduling criteria.

As mentioned, the machine learning pipeline management system can implement a generated machine learning pipeline. More specifically, the machine learning pipeline management system can implement instructions in the machine learning pipeline file to generate, train, and deploy a machine learning model based on the variety of user selections. Accordingly, the machine learning pipeline management system can automatically generate and implement a machine learning pipeline based on user selections.

Further, in one or more embodiments, the machine learning pipeline management system provides a machine learning pipeline graphical user interface for monitoring and managing machine learning pipelines. More specifically, the machine learning pipeline management system can monitor activity corresponding to the machine learning pipeline in real-time. Accordingly, in some embodiments, the machine learning pipeline generates the machine learning pipeline graphical user interface utilizing real-time machine learning pipeline activity and data. Thus, the machine learning pipeline management system can update the machine learning pipeline graphical user interface in real-time. Further, in one or more embodiments, the machine learning pipeline management system can receive and implement user input updating or modifying machine learning pipeline operations via the machine learning pipeline graphical user interface.

Additionally, in some embodiments, the machine learning pipeline management system evaluates and stores machine learning pipelines in a machine learning pipeline registry. To illustrate, in one or more embodiments, the machine learning pipeline management system continuously integrates new machine learning pipeline files and other machine learning pipeline data into the machine learning pipeline registry. More specifically, in one or more embodiments, the machine learning pipeline management system tests the machine learning pipeline file to ensure that the machine learning pipeline generates an accurate machine learning model. Bas ed on the results of the test, the machine learning pipeline management system determines whether to merge the machine learning pipeline into the machine learning pipeline registry. Additionally, in some embodiments, the machine learning pipeline management system identifies existing machine learning pipeline file in the machine learning pipeline registry to update based on the new machine learning pipeline file.

Further, in some embodiments, the machine learning pipeline management system utilizes continuous deployment to schedule and deploy machine learning pipelines. More specifically, in one or more embodiments, the machine learning pipeline management system detects and utilizes deployment parameters from a machine learning pipeline to schedule deployment of the machine learning pipeline and/or the corresponding machine learning model. Accordingly, the machine learning pipeline management system can deploy machine learning models and machine learning pipelines based on machine learning pipeline settings, including into existing computing infrastructure.

Additionally, the machine learning pipeline management system can monitor machine learning pipelines to identify errors and provide error notifications. More specifically, in one or more embodiments, the machine learning pipeline management system continuously monitors machine learning pipelines and machine learning models across a variety of applications. Further, the machine learning pipeline management system can identify operational data and report the operational data via machine learning pipeline graphical user interfaces. Accordingly, the machine learning pipeline management system provides an efficient generation, implementation, and monitoring of machine learning pipelines and corresponding machine learning models.

The machine learning pipeline management system provides many advantages and benefits over conventional systems and methods. For example, by utilizing a machine learning pipeline registry, the machine learning pipeline management system improves accuracy relative to conventional systems. Specifically, by utilizing the machine learning pipeline registry to store and retrieve tested machine learning model templates, ground-truth datasets, scheduling infrastructure, and various other machine learning pipeline data, the machine learning pipeline management system improves accuracy over conventional systems. Indeed, by utilizing continuous integration to test entries in the machine learning pipeline registry, the machine learning pipeline management system improves accuracy of machine learning pipelines integrating components from the machine learning pipeline registry. This improved accuracy reduces or eliminates the excessive trial and error necessitated by many conventional systems.

Additionally, the machine learning pipeline management system improves efficiency over conventional systems. By generating and implementing machine learning model pipelines via a machine learning pipeline generating graphical user interface, the machine learning pipeline management system reduces or eliminates excessive user interactions across various systems to generate machine learning pipelines. More specifically, the machine learning pipeline management system reduces or eliminates these excessive interactions by providing options for a variety of steps for a machine learning pipeline within a single graphical user interface, the machine learning pipeline management system. Further, the increased accuracy of these generated machine learning pipelines further reduces interactions required during trial and error of conventional systems.

Additionally, the machine learning pipeline management system improves efficiency by conserving computational resources such as computing time and processing power in generating and implementing machine learning pipelines. More specifically, the machine learning pipeline management system conserves computational resources by integrating machine learning model generation into a machine learning pipeline managed via a single integrated system. Further, the machine learning pipeline management system conserves computational resources by utilizing and continuously integrating and updating a machine learning pipeline registry for various machine learning pipeline resources.

As illustrated by the foregoing discussion, the present disclosure utilizes a variety of terms to describe features and benefits of the machine learning pipeline management system. Additional detail is now provided regarding the meaning of these terms. For example, as used herein, the term “machine learning pipeline” refers to an automated workflow for generating and/or implementing a machine learning model. To illustrate, a machine learning pipeline can include steps of data (e.g., ground-truth data) preparation, machine learning model preprocessing, machine learning model training, and/or machine learning model deployment.

Also, as used herein, the term “machine learning pipeline file” refers to instructions for executing a machine learning pipeline. In particular, the term “machine learning pipeline” can include a docker image file. Further, as used herein, the term “ground-truth dataset” refers to a set of data utilized as ground-truth for training a machine learning model. Relatedly, as used herein, the term “training parameters” refers to conditions or settings utilized in training a machine learning model. In particular, the term “training parameters” can include configuration variables for various portions of the machine learning model training process.

Additionally, as used herein, the term “scheduling infrastructure” refers to a time-based configuration for running computing processes. In particular, the term “scheduling infrastructure” can include a scheduled computer action, remote programs, etc. To illustrate, a scheduling infrastructure can schedule various machine learning model and/or machine learning pipeline functions, such as running a machine learning pipeline, implementing or integrating a machine learning model, etc.

Further, as used herein, the term “machine learning pipeline registry” refers to a database storing machine learning pipeline and/or machine learning model data. In one or more embodiments, the machine learning pipeline management system can test machine learning model and machine learning pipeline data before integrating it into a machine learning pipeline registry via continuous integration. In particular, the term “machine learning pipeline registry” can include template machine learning models, ground-truth datasets, training parameters, scheduling parameters, etc.

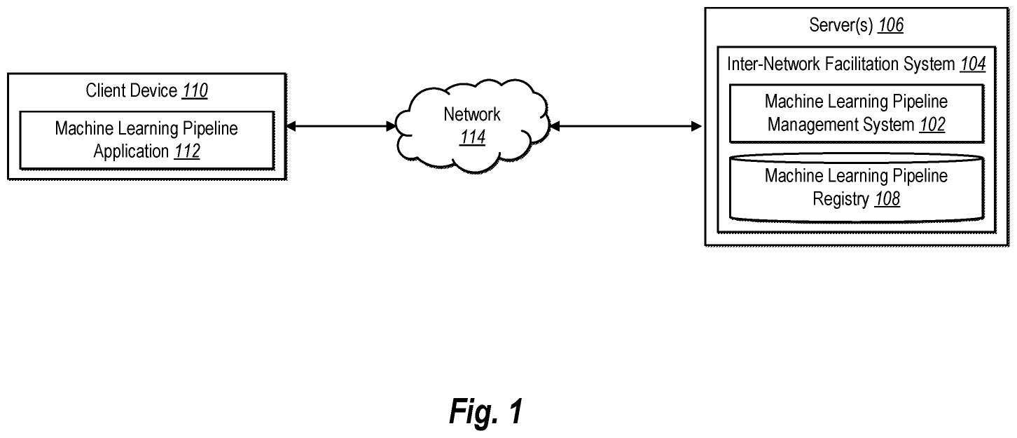

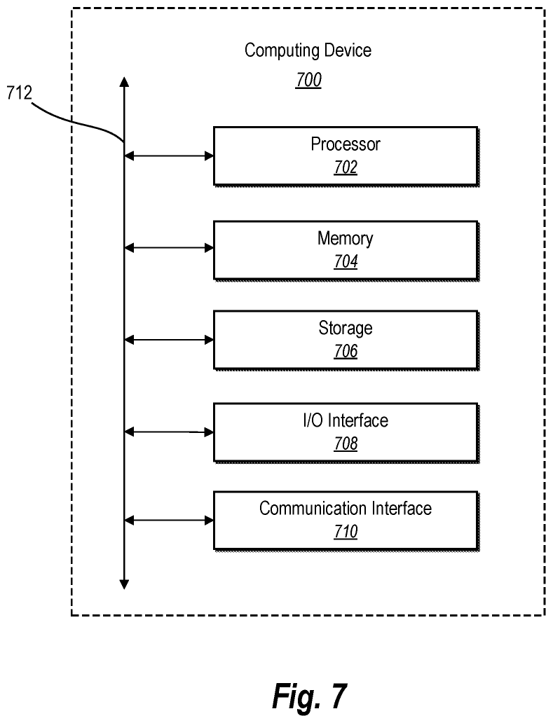

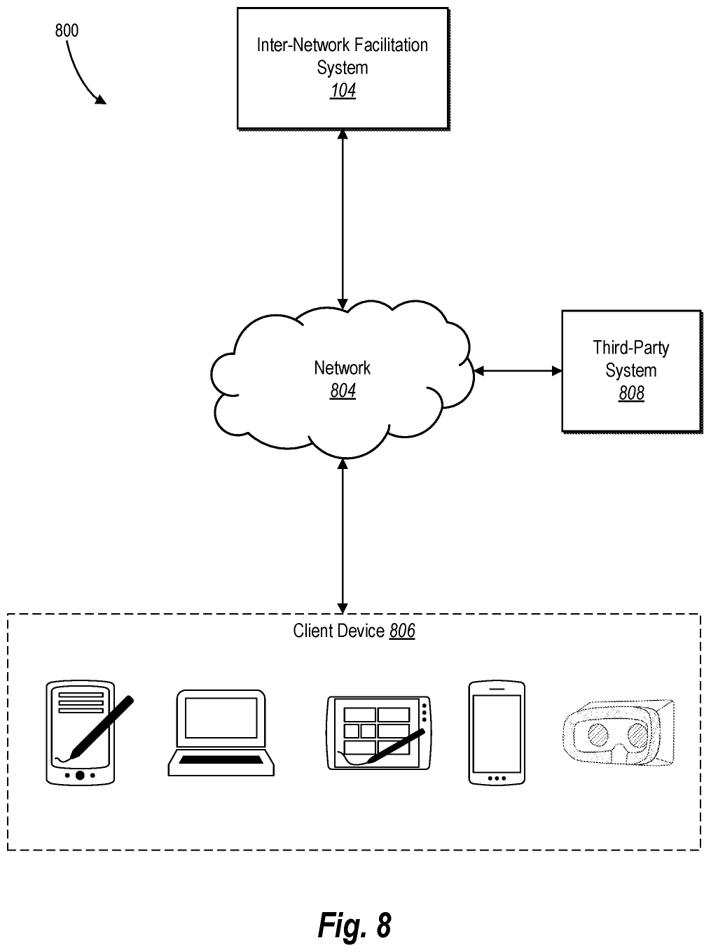

Additional detail regarding the machine learning pipeline management system will now be provided with reference to the figures. In particular, FIG. 1 illustrates a block diagram of a system environment for implementing a machine learning pipeline management system 102 in accordance with one or more embodiments. As shown in FIG. 1, the environment includes server(s) 106 housing the machine learning pipeline management system 102 as part of an inter-network facilitation system 104. The server(s) 106 also include a machine learning pipeline registry 108. The environment of FIG. 1 also includes a client device 110 and a machine learning pipeline application 112. The server(s) 106 can include one or more computing devices to implement the machine learning pipeline management system 102. Additional description regarding the illustrated computing devices (e.g., the server(s) 106, the client device 110) is provided with respect to FIGS. 7-8 below.

As shown, the machine learning pipeline management system 102 utilizes the network 114 to communicate with the client device 110. The network 114 may comprise any network described in relation to FIGS. 7-8. For example, the client device 110 can communicate machine learning pipeline user selections, such as a template machine learning model selection, ground-truth dataset selections and training parameters selections. In response, the machine learning pipeline management system 102 can communicate with the client device 110 to provide various machine learning model pipeline data via a machine learning pipeline graphical user interface.

As further illustrated in FIG. 1, the environment includes the server(s) 106. In some embodiments, the server(s) 106 comprise a content server and/or a data collection server. Additionally, or alternatively, the server(s) 106 comprise an application server, a communication server, a web-hosting server, a social networking server, a digital content management server, or a financial payment server.

Moreover, as shown in FIG. 1, the server(s) 106 implement an inter-network facilitation system 104. In one or more embodiments, the inter-network facilitation system 104 (or the machine learning pipeline management system 102) communicates with the client device 110 to receive or send various machine learning pipeline and/or machine learning model data. More specifically, the inter-network facilitation system 104 (or the machine learning pipeline management system) can communicate with the client device 110 to generate and/or implement a machine learning pipeline.

Additionally, the server(s) 106 include a machine learning pipeline registry 108. In some embodiments, the machine learning pipeline registry 108 is a database including a variety of machine learning pipeline data. For example, in one or more embodiments, the machine learning pipeline management system tests and stores machine learning pipelines in the machine learning pipeline registry 108. Further, in some embodiments, the machine learning pipeline registry 108 includes scheduling data, template machine learning models, ground-truth datasets, training parameters, etc.

Further, the environment includes the client device 110. The client device 110 can include one of a variety of computing devices, including a smartphone, tablet, smart television, desktop computer, laptop computer, virtual reality device, augmented reality device, or other computing device as described in relation to FIGS. 7-8. Although FIG. 1 illustrates one client device 110, the environment can include many different client devices connected to each other via the network 114. Further, in some embodiments, the client device 110 receives user input and provides information pertaining to generating, modifying, monitoring, and/or deploying a machine learning pipeline and/or machine learning model to the server(s) 106.

Moreover, as shown, the client device 110 includes a corresponding machine learning pipeline application 112. The machine learning pipeline application 112 can include a web application, a native application, etc. installed on the client device 110 (e.g., a mobile application, a desktop application, a plug-in application, etc.), or a cloud-based application where part of the functionality is performed by the server(s) 106. In some embodiments, the machine learning pipeline management system 102 causes the machine learning pipeline application 112 to present or display a machine learning pipeline generation graphical user interface and/or a machine learning pipeline graphical user interface.

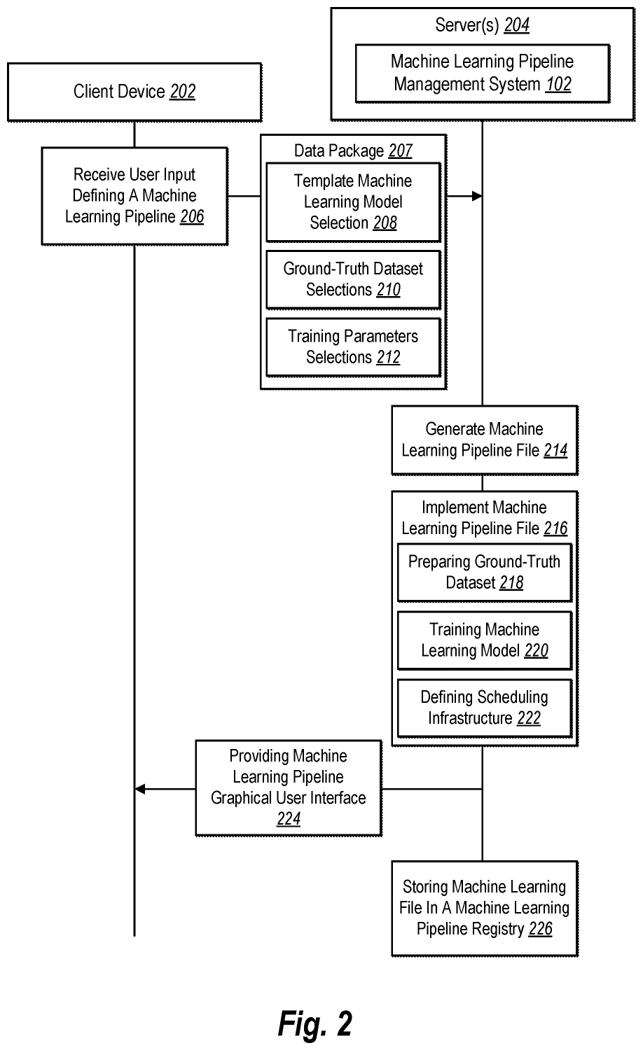

As discussed briefly above, the machine learning pipeline management system 102 can generate and implement a machine learning pipeline based on user input. FIG. 2 illustrates a process for generating, implementing, and storing a machine learning pipeline file in accordance with one or more embodiments. More specifically, FIG. 2 illustrates communication between a client device 202 and server(s) 204 including the machine learning pipeline management system 102.

As shown in FIG. 2, the client device 202 performs an act 206 of receiving user input defining a machine learning pipeline. In one or more embodiments, the machine learning pipeline management system 102 receives user input corresponding to a variety of structures, settings, and other criteria for a machine learning pipeline. To illustrate, in one or more embodiments, the client device 202 displays a machine learning pipeline generation graphical user interface that includes a variety of options for generating a machine learning pipeline. For example, the client device 202 can receive user input selecting a template machine learning model, a ground-truth dataset, and/or training parameters. Additionally, the client device 202 can receive user input selecting a name for the machine learning pipeline file, specifications of the client device 202 or of another computing device that will run the machine learning pipeline file.

In one or more embodiments, the client device 202 displays a machine learning pipeline generation graphical user interface and receives user input via the machine learning pipeline generation graphical user interface. Further, the machine learning pipeline generation graphical user interface can include a variety of options for various machine learning pipeline criteria. To illustrate, the machine learning pipeline generation graphical user interface can include options for data existing in a machine learning pipeline registry, such as existing template machine learning models, organized ground-truth datasets, etc. The machine learning pipeline generation graphical user interface can also include options for entering criteria for generation of new machine learning model templates, new ground-truth datasets, etc.

Further, the client device can send a data package 207 to the machine learning pipeline management system 102. As shown in FIG. 2, the data package 207 includes a template machine learning model selection 208, ground-truth dataset selections 210, and training parameters selections 212. The client device 202 can send the data package 207 including any of a variety of user selections, including via the machine learning pipeline generation graphical user interface. Though FIG. 2 illustrates the template machine learning model selection 208, the ground-truth dataset selections 210, and the training parameters selections 212, the client device 202 can detect and send a variety of user selections of a variety of machine learning pipeline criteria.

As also shown in FIG. 2, the machine learning pipeline management system 102 can perform an act 214 of generating a machine learning pipeline file. More specifically, the machine learning pipeline management system 102 generates instructions for preparing, training, and deploying a machine learning model. More specifically, the machine learning pipeline management system 102 generates instructions for preparing a ground-truth dataset based on the user selections.

Further, the machine learning pipeline management system 102 can generate instructions for training a machine learning model by generating or retrieving an untrained machine learning model based on user selection of template machine learning model structure and/or selection of a template machine learning model. Further, the machine learning pipeline management system 102 and implementing selected training parameters and utilizing the user-selected and prepared ground-truth data.

As part of act 214, the machine learning pipeline management system 102 can generate any computing infrastructure necessary to implement the machine learning pipeline. To illustrate, in one or more embodiments, the machine learning pipeline management system 102 generates a schedule trigger corresponding to the machine learning pipeline that triggers execution or implementation of the machine learning pipeline. More specifically, in one or more embodiments, the machine learning pipeline management system 102 generates the schedule trigger based on the scheduling criteria selected by the user (e.g., at act 206). The machine learning pipeline management system 102 can implement schedule triggers based on a variety of criteria, including time or date intervals and/or system meeting or receiving various other criteria.

The machine learning pipeline management system 102 generates the machine learning pipeline file such that the machine learning pipeline management system 102 can implement the machine learning pipeline on the server(s) 204 or on another system device, including the client device 202. In one or more embodiments, the machine learning pipeline management system 102 generates the machine learning pipeline file as a docker image file. Accordingly, the machine learning pipeline management system 102 can prepare the machine learning pipeline file such that the machine learning pipeline is ready to run.

Additionally, as shown in FIG. 2, the machine learning pipeline management system 102 can perform an act 216 of implementing a machine learning pipeline file. The act 216 can include an act 218 of preparing a ground-truth dataset. The machine learning pipeline management system 102 prepares the ground-truth dataset based on the instructions in the machine learning pipeline file. More specifically, as discussed above, the machine learning pipeline management system 102 generates a ground-truth dataset based on user selections. For example, in one or more embodiments, the machine learning pipeline management system 102 retrieves ground-truth data from a machine learning pipeline registry and/or from a remote database. In some embodiments, the machine learning pipeline management system 102 retrieves and organizes data based on criteria for the ground-truth dataset selected by the user. In addition, or in the alternative, the machine learning pipeline management system 102 retrieves a specific existing ground-truth dataset already existing in a machine learning pipeline registry.

Further, the act 216 can include an act 220 of training a machine learning model. More specifically, the machine learning pipeline management system 102 generates or retrieves an untrained machine learning model based on user selections. To illustrate, in some embodiments, the machine learning pipeline file includes instructions to generate an untrained model based on user-selected machine learning model structures. Additionally, in some embodiments, the machine learning pipeline file includes instructions to retrieve a user-selected template machine learning model from a machine learning pipeline registry.

The machine learning pipeline management system 102 can utilize the untrained model, the ground-truth dataset, and user-selected training parameters. More specifically, in one or more embodiments, the machine learning pipeline management system 102 utilizes the ground-truth data as input for the untrained machine learning model. The untrained machine learning model then generates predicted outputs and the machine learning pipeline management system 102 records these batch predictions.

Further, in one or more embodiments, the machine learning pipeline management system 102 compares the machine learning pipeline output to the ground-truth dataset utilizing a loss function. In some embodiments, the loss function is determined from training parameters selected by the user at the act 206. Based on the determined loss or difference from the loss function, the machine learning pipeline management system 102 adjusts one or more weights within the machine learning model. By repeating this process, the machine learning pipeline management system 102 runs training iterations to iteratively adjust the weights for the machine learning model. After adjustment, the machine learning model can generate improve predictions. In some cases, the machine learning pipeline management system 102 runs training iterations until the machine learning pipeline management system 102 determines that a subsequent loss from the loss function is within a minimum threshold or a threshold number of training iterations is reached. The machine learning pipeline management system 102 can run training iterations based on the training parameters defined at the act 206 and prepared as part of the machine learning pipeline file at the act 214. To illustrate, the threshold criteria for training can be based on user selections.

In some embodiments, the machine learning pipeline management system 102 records batch predictions made during training of a machine learning model. Accordingly, the machine learning pipeline management system 102 can store these batch predictions in a machine learning pipeline registry. Additionally, the machine learning pipeline management system 102 can utilize the batch predictions to evaluate performance of the machine learning model.

The act 216 can also perform an act 222 of defining scheduling infrastructure. To illustrate, the machine learning pipeline management system 102 can generate one or more schedule triggers corresponding to the machine learning pipeline. As discussed above, the machine learning pipeline management system 102 generates schedule triggers based on user selection of options for when to run the machine learning pipeline. For example, the machine learning pipeline management system 102 can schedule the machine learning pipeline to run at specific intervals and/or based on determining that particular criteria are satisfied. For example, the machine learning pipeline management system 102 can generate schedule triggers that cause the machine learning pipeline to run every first of the month at 9:00 AM, in response to determining 100 new users have signed up, or receiving 1,000 requests within one hour.

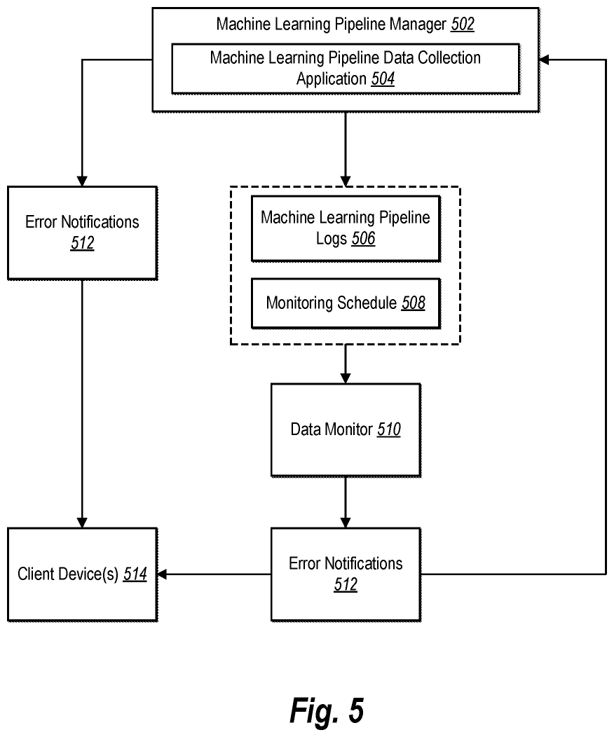

As further shown in FIG. 2, the machine learning pipeline management system 102 can perform an act 224 of providing a machine learning pipeline graphical user interface. The machine learning pipeline management system 102 can generate a machine learning pipeline graphical user interface including a variety of data corresponding to machine learning pipelines and/or machine learning models. More specifically, as will be discussed in greater detail below with regard to FIG. 5, in one or more embodiments, the machine learning pipeline management system 102 continuously monitors the activity of machine learning pipelines and/or machine learning models.

The machine learning pipeline management system 102 can generate and provide the machine learning pipeline graphical user interface to the client device 202 including a variety of data corresponding to these monitored activities. For example, the machine learning pipeline management system 102 can monitor and report current status, activity logs, actions taken by the system as a result of machine learning pipelines and/or machine learning models, errors, etc. Further, in one or more embodiments, the machine learning pipeline management system 102 provides options to modify machine learning pipelines and/or machine learning models, machine learning pipeline and/or machine learning model code, scalable data preparation, and a variety of other options in the machine learning pipeline graphical user interface.

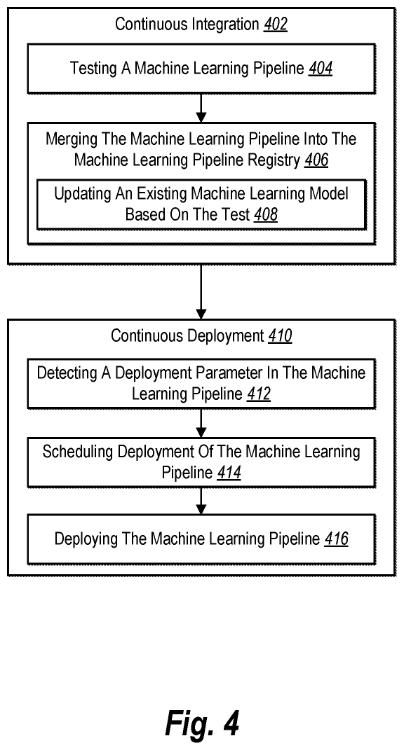

Additionally, the machine learning pipeline management system 102 can perform an act 226 of storing machine learning files in a machine learning pipeline registry. More specifically, as will be discussed in greater detail below with regard to FIG. 4, in one or more embodiments, the machine learning pipeline management system 102 evaluates machine learning pipelines and merges the machine learning pipelines into a machine learning pipeline registry. The machine learning pipeline management system 102 tests a machine learning pipeline by monitoring the machine learning pipeline during running or implementation. Then, the machine learning pipeline management system 102 can store or integrate machine learning pipelines with threshold efficiency and/or accuracy. Additionally, in one or more embodiments, the machine learning pipeline management system 102 identifies an existing machine learning model to update based on the tested machine learning model.

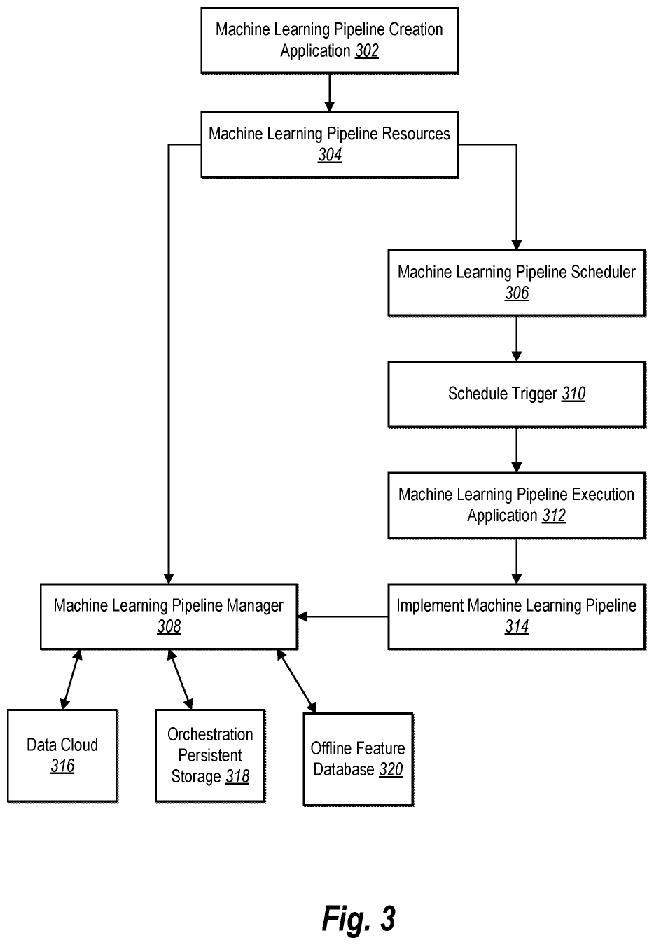

As discussed above, the machine learning pipeline management system 102 can implement and manage various machine learning pipelines. FIG. 3 illustrates a variety of applications and processes that the machine learning pipeline management system 102 can utilize to manage machine learning pipelines. More specifically, FIG. 3 illustrates applications and processes for generating, executing, and managing machine learning pipelines and communicating processes with a user computing device.

For example, FIG. 3 illustrates that the machine learning pipeline management system 102 can include a machine learning pipeline creation application 302. As discussed above with regard to FIG. 2, the machine learning pipeline management system 102 can generate machine learning pipelines based on received user inputs. To illustrate, the machine learning pipeline management system 102 can generate machine learning pipeline files including instructions for executing a machine learning pipeline. Additionally, in some embodiments, the machine learning pipeline execution application 312 runs various scripts to develop and/or test machine learning pipelines and machine learning pipeline components. Further, in some embodiments, the machine learning pipeline creation application 302 adds machine learning pipelines to the machine learning pipeline registry and/or updates machine learning pipelines in the machine learning pipeline registry.

As shown in FIG. 3, the machine learning pipeline creation application 302 provides machine learning pipeline resources 304 to a machine learning pipeline scheduler 306 and a machine learning pipeline manager 308. In one or more embodiments, the machine learning pipeline management system 102 also stores the machine learning pipeline resources 304 in a machine learning pipeline registry and provides the machine learning pipeline resources 304 to the machine learning pipeline scheduler 306 via the machine learning pipeline registry.

In some embodiments, the machine learning pipeline management system 102 utilizes the machine learning pipeline registry to maintain ground-truth data and batch predictions corresponding to machine learning pipelines and/or machine learning models defined by users. Thus, the machine learning pipeline management system 102 can utilize the machine learning pipeline registry to track machine learning pipelines and/or machine learning models. Further, in some embodiments, the machine learning pipeline management system 102 utilizes the machine learning pipeline registry to provide efficient searchability of machine learning pipeline assets via a centralized repository. Further, in one or more embodiments, the machine learning pipeline management system 102 tracks and records creating users associated with various assets for efficient retrieval.

Additionally, as shown in FIG. 3, the machine learning pipeline scheduler 306 provides a schedule trigger 310 to a machine learning pipeline execution application 312. As discussed above, the machine learning pipeline management system 102 generates the schedule trigger 310 to trigger implementation of a machine learning pipeline management system 102 based on user selections of time and/or criteria for implementation. In one or more embodiments, the machine learning pipeline scheduler 306 generates and sends the schedule trigger 310 based on determining that the schedule trigger 310 is satisfied. Thus, in some embodiments, the machine learning pipeline execution application 312 automatically executes the corresponding machine learning pipeline in response to receiving the schedule trigger 310. In addition, or in the alternative, upon receiving the schedule trigger, the machine learning pipeline execution application 312 implements the corresponding machine learning pipeline management system 102 based on determining that the schedule trigger 310 is satisfied.

Further, the machine learning pipeline execution application 312 performs an act 314 of implementing the machine learning pipeline. In one or more embodiments, the machine learning pipeline execution application 312 includes a unified infrastructure to deploy machine learning pipelines within the machine learning pipeline management system 102. In one or more embodiments, the machine learning pipeline management system 102 executes machine learning pipelines in accordance with the schedule trigger 310 and a variety of other schedule triggers unique to a variety of machine learning pipelines. Accordingly, the machine learning pipeline execution application 312 can execute a machine learning pipeline file automatically based on a variety of criteria without need for repeated user interaction. For example, based on a single user selection during machine learning pipeline creation of a weekly interval, the machine learning pipeline execution application 312 can execute the corresponding machine learning pipeline every Friday at 5:00 pm EST without any need for further interaction from a user.

Additionally, in one or more embodiments, the machine learning pipeline execution application 312 provides the machine learning pipeline and other data corresponding to the machine learning pipeline to the machine learning pipeline manager 308. To illustrate, the machine learning pipeline execution application 312 can report when a machine learning pipeline management system 102 is being run, resources utilized by a machine learning pipeline, batch predictions from the machine learning pipeline, etc.

Further, as mentioned above, the machine learning pipeline management system 102 can provide a variety of machine learning pipeline data and machine learning pipeline management options via a machine learning pipeline graphical user interface. In some embodiments, the machine learning pipeline manager 308 manages the machine learning pipeline, including generating and providing a machine learning pipeline graphical user interface. To illustrate, the machine learning pipeline manager 308 can generate the machine learning pipeline graphical user interface including the machine learning pipeline data received from the machine learning pipeline execution application 312.

Further, in some embodiments, the machine learning pipeline manager 308 provides the machine learning pipeline graphical user interface including a visual editor for viewing, tracking, and managing lifecycle of machine learning pipelines and machine learning pipeline resources. The machine learning pipeline manager 308 can also provide a graph view of machine learning pipelines via the machine learning pipeline graphical user interface. Additionally, in some embodiments, the machine learning pipeline graphical user interface includes metadata and status of each step within am machine learning pipeline to facilitate viewing and managing end-to-end lifecycles of machine learning pipeline workflows.

As shown in FIG. 3, the machine learning pipeline manager 308 communicates with a data cloud 316, an orchestration persistent storage 318, and an offline feature database 320. Accordingly, the machine learning pipeline manager 308 can utilize and provide data from a variety of sources via the machine learning pipeline graphical user interface. Additionally, the machine learning pipeline management system 102 can send data for storage to the data cloud 316, the orchestration persistent storage 318, and the offline feature database 320, in addition to a machine learning pipeline registry.

In one or more embodiments, the machine learning pipeline management system 102 generates instances to implement steps of machine learning pipelines and shuts these instances down after completion of the steps. Accordingly, in one or more embodiments, storage of these steps is ephemeral. However, in one or more embodiments, the machine learning pipeline execution application 312 provides data collected during execution of a machine learning pipeline to the machine learning pipeline manager 308. In some embodiments, the machine learning pipeline manager 308 sends this data for storage in the data cloud 316, the orchestration persistent storage 318, the offline feature database 320, and/or a machine learning pipeline registry within the machine learning pipeline management system 102.

Accordingly, in one or more embodiments, management and/or execution of machine learning pipelines is persistently supported through consistent interaction with the data cloud 316, the orchestration persistent storage 318, the offline feature database 320, and/or a machine learning pipeline registry within the machine learning pipeline management system 102. In some embodiments, the machine learning pipeline creation application 302 queries the machine learning pipeline manager 308 and/or the data cloud 316, the orchestration persistent storage 318, the offline feature database 320, and/or a machine learning pipeline registry directly during generation of machine learning pipelines.

Additionally, in one or more embodiments, the machine learning pipeline management system 102 provides orchestration infrastructure including a persistent storage layer. In some embodiments, the machine learning pipeline manager 308 facilitates user interaction with the storage layer via the machine learning pipeline graphical user interface. More specifically, the machine learning pipeline manager 308 can receive user interaction indicating organization or re-organization of machine learning pipeline data among the machine learning pipeline manager 308 and/or the data cloud 316, the orchestration persistent storage 318, the offline feature database 320, and/or a machine learning pipeline registry. In some embodiments, the machine learning pipeline manager 308 utilizes underlying containers to implement wrappers around entry-point script maintained by machine learning containerization. Thus, in some embodiments, the machine learning pipeline management system 102 can will copy machine learning pipeline assets to various locations when container execution is finished.

Additionally, in one or more embodiments, the machine learning pipeline management system 102 persistently stores machine learning pipeline management system 102 in a version-controlled source. Thus, the machine learning pipeline management system 102 can track and maintain executed machine learning pipelines across different versions (e.g., before and after modifications). In some embodiments, the machine learning pipeline management system 102 utilizes an application to define machine learning pipelines throughout different stages of development.

The machine learning pipeline management system 102 manages a variety of machine learning pipeline functions. For example, FIG. 4 illustrates including continuous integration and continuous deployment of machine learning models. More specifically, the machine learning pipeline management system 102 can continuously integrate machine learning pipelines and associated data into a machine learning pipeline registry. Further, the machine learning pipeline management system 102 can continuously deploy machine learning pipelines into existing computing structures.

As shown in FIG. 4, the continuous integration 402 can include an act 404 of testing a machine learning pipeline. In some embodiments, the machine learning pipeline management system 102 tests the machine learning pipeline by running the machine learning pipeline and determining loss from a loss function at the end of training the machine learning model. In some embodiments, the machine learning pipeline management system 102 compares this loss to a threshold accuracy to determine whether to merge the machine learning pipeline into the machine learning pipeline registry. In addition, or in the alternative, the machine learning pipeline management system 102 can execute the machine learning pipeline and monitor the machine learning pipeline for errors. The machine learning pipeline management system 102 can then utilize detected errors to determine whether to exclude the machine learning pipeline from the machine learning pipeline registry. For example, the machine learning pipeline management system 102 can utilize an error threshold.

Further, as shown in FIG. 4 the continuous integration 402 can include an act 406 of merging the machine learning pipeline into the machine learning pipeline registry. In some embodiments, the machine learning pipeline management system 102 stores the machine learning pipeline into the machine learning pipeline registry as a new entry. Further, the machine learning pipeline management system 102 can store other machine learning pipeline data, such as ground-truth datasets, untrained machine learning models, batch predictions, machine learning model performance, etc. in the machine learning pipeline registry.

Additionally, as shown in FIG. 4, the act 406 can include an act 408 of updating an existing machine learning model based on the test. For example, the machine learning pipeline management system 102 can compare the tested machine learning pipeline to existing machine learning pipelines already stored in the machine learning pipeline registry. If the machine learning pipeline management system 102 detects a machine learning pipeline with sufficient similarity to the tested machine learning pipeline, the machine learning pipeline management system 102 can update the existing machine learning pipeline with the machine learning pipeline. In some embodiments, the machine learning pipeline management system 102 can also updates other machine learning pipeline data within the machine learning pipeline registry, such as ground-truth datasets, untrained machine learning models, batch predictions, etc.

In addition to managing continuous integration 402 of machine learning models and machine learning pipelines, the machine learning pipeline management system 102 can manage the continuous deployment 410 of machine learning models and machine learning pipelines. As shown in FIG. 4, the continuous deployment 410 can include an act 412 of detecting a deployment parameter in the machine learning pipeline. More specifically, the machine learning pipeline management system 102 can execute a machine learning pipeline file that includes a deployment parameter. Upon reaching the deployment step indicated by the deployment parameter, the machine learning pipeline management system 102 can deploy the machine learning pipeline, including into existing system infrastructure.

To illustrate, as shown in FIG. 4, the continuous deployment 410 can include an act 414 of scheduling deployment of the machine learning pipeline. More specifically, the machine learning pipeline management system 102 utilizes orchestration infrastructure and corresponding schedule triggers to implement machine learning pipelines at particular times. Additionally, as mentioned above, the machine learning pipeline management system 102 introduces a deployment parameter to denote whether the machine learning pipeline should be deployed during production. In some embodiments, during this scheduling, the machine learning pipeline management system 102 checks the machine learning pipeline for accuracy (e.g., via syntactical checks).

Additionally, as shown in FIG. 4, the continuous deployment 410 can include an act 416 of deploying the machine learning pipeline. More specifically, the machine learning pipeline management system 102 deploys a machine learning pipeline based on defined scheduling infrastructure, including schedule triggers. In some embodiments, the machine learning pipeline management system 102 runs an old machine learning pipeline parallel to a new machine learning pipeline for a specified number of iterations during deployment.

Additionally, in some embodiments, the machine learning pipeline management system 102 utilizes an implementation application to implement changes to deployed machine learning pipelines that are updated in a machine learning pipeline registry. More specifically, the machine learning pipeline management system 102 detects an update to a machine learning pipeline and determines that the machine learning pipeline registry is currently deployed. Upon detecting this change, the machine learning pipeline management system 102 re-deploys the updated machine learning pipeline registry. In some embodiments, the machine learning pipeline management system 102 schedules this re-deployment based on a deployment parameter in the updated machine learning pipeline.

Further, in some embodiments, the machine learning pipeline management system 102 terminates machine learning pipeline resources based no determining that a machine learning pipeline is not active and/or has not been active for a threshold time period. In addition, or in the alternative, the machine learning pipeline management system 102 can remove a machine learning pipeline from a system based on determining that the machine learning pipeline is no longer present in a machine learning pipeline registry.

As mentioned above, in one or more embodiments, the machine learning pipeline management system 102 monitors various machine learning models and/or machine learning pipelines. Further, as discussed above with regard to FIG. 3, the machine learning pipeline management system 102 can provide a machine learning pipeline graphical user interface for managing machine learning pipelines. In one or more embodiments, the machine learning pipeline management system provides various notifications regarding machine learning pipelines in such machine learning pipeline graphical user interfaces. FIG. 5 provides additional detail for a process for continuous monitoring of machine learning pipelines and providing error notifications via a machine learning pipeline graphical user interface.

More specifically, in one or more embodiments, the machine learning pipeline management system 102 tracks actions taken as a result of a deployed machine learning pipeline and/or functions of implemented machine learning models. In some embodiments, the machine learning pipeline management system 102 can store and retrieve machine learning model input data as well as output and corresponding system action(s). Further, in some embodiments, the machine learning pipeline management system 102 analyzes these inputs and outputs to audit machine learning pipelines and/or machine learning models for errors. FIG. 5 illustrates various functions that the machine learning pipeline management system 102 can utilize to identify these errors.

As shown in FIG. 5, the machine learning pipeline management system 102 utilizes a machine learning pipeline manager 502 including a machine learning pipeline data collection application 504. Further, in some embodiments, the machine learning pipeline management system 102 includes a data monitor 510. As shown in FIG. 5, both the machine learning pipeline manager 502 and the data monitor 510 can provide error notifications 512 to client device(s) 514.

In one or more embodiments, the machine learning pipeline manager 502 manages and reports various machine learning pipeline functions to client devices, as discussed above in FIG. 3 with regard to the machine learning pipeline manager 308. In addition, the machine learning pipeline manager 508 can detect errors in various machine learning pipelines. More specifically, the machine learning pipeline management system 102 can utilize the machine learning pipeline data collection application 504 to continuously monitor a variety of machine learning pipelines and/or machine learning models across a system (e.g., the inter-network facilitation system). The machine learning pipeline management system 102 can also communicate with the data monitor 510 to identify errors in the data collected via the machine learning pipeline data collection application 504.

As shown in FIG. 5, in one or more embodiments, the machine learning pipeline manager 502 can provide machine learning pipeline logs 506 and a monitoring schedule 508 to the data monitor 510. More specifically, I one or more embodiments, the machine learning pipeline manager 502 provides machine learning pipeline data from machine learning pipeline creation, machine learning pipeline execution, machine learning pipeline storage, etc. In some embodiments, the data monitor 510 utilizes the machine learning pipeline logs 506 and the monitoring schedule 508 to identify errors in corresponding machine learning pipelines.

Accordingly, in one or more embodiments, the data monitor generates error notifications 512 and provides the error notifications 512 to the client device(s) 514 and/or the machine learning pipeline manager 502. In some embodiments, the client device(s) 514 display the error notifications 512 received from the machine learning pipeline manager 502 and/or the client device(s) 514 via the machine learning pipeline management graphical user interface.

Further, in some embodiments, the machine learning pipeline management system 102 can compare machine learning pipelines running parallel performing the same or similar tasks. The machine learning pipeline management system 102 can evaluate the performance of each of a set of parallel machine learning pipelines to determine the most accurate and/or efficient parallel machine learning pipeline. The machine learning pipeline can accordingly provide a notification of the performance of each of the parallel machine learning models to the client device(s) 514. In addition, or in the alternative, the machine learning pipeline management system 102 can automatically deploy the most accurate and/or most efficient of the parallel machine learning pipelines.

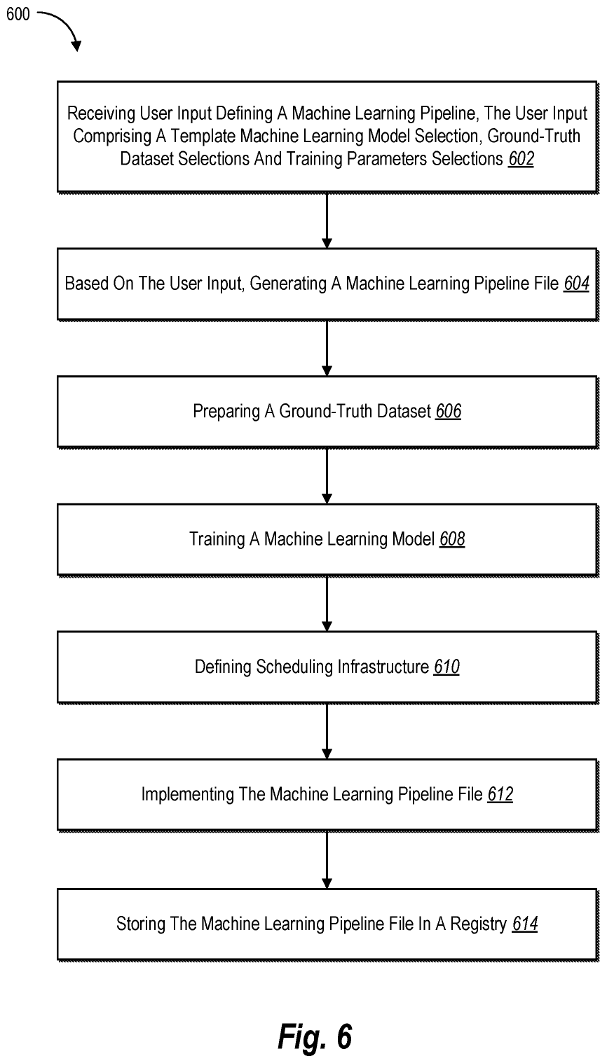

FIGS. 1-5, the corresponding text, and the examples provide a number of different methods, systems, devices, and non-transitory computer-readable media of the machine learning pipeline management system 102. In addition to the foregoing, one or more embodiments can also be described in terms of flowcharts comprising acts for accomplishing a particular result, as shown in FIG. 6. FIG. 6 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts 600 for generating and implementing a machine learning pipeline file in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer-readable medium can comprise instructions that, when executed by one or more processors, cause a computing device to perform the acts of FIG. 6. In some embodiments, a system can perform the acts of FIG. 6.

As shown in FIG. 6, the series of acts 600 includes an act 602 for receiving user input defining a machine learning pipeline, the user input comprising a template machine learning model selection, ground-truth dataset selections and training parameters selections. Specifically, the act 602 can include receiving the user input via a unified machine learning parameter graphical user interface. Additionally, in one or more embodiments, the act 602 includes generating an untrained machine learning model for training based on the template machine learning model selection, wherein the machine learning model selection comprises a template machine learning model from the machine learning pipeline registry.

Additionally, as shown in FIG. 6, the series of acts 600 includes an act 604 for, based on the user input, generating a machine learning pipeline file. In particular, the act 604 can include based on the user input, generate a machine learning pipeline file comprising instructions for preparing a ground-truth dataset based on the ground-truth dataset selections, training a machine learning model based on the template machine learning model and the training parameters selections.

Further, as shown in FIG. 6, the series of acts 600 includes an act 606 for preparing a ground-truth dataset. In particular, the act 606 can include based on the user input, generating a machine learning pipeline file comprising instructions for ground-truth dataset based on the ground-truth dataset selections.

Also, as shown in FIG. 6, the series of acts 600 includes an act 608 for training a machine learning model. In particular, the act 608 can include generating a machine learning pipeline file comprising instructions for training a machine learning model based on the template machine learning model and the training parameters selections. Specifically, the act 608 can include generating a machine learning pipeline graphical user interface for viewing, tracking, and managing the machine learning pipeline.

As also shown in FIG. 6, the series of acts 600 includes an act 610 for defining scheduling infrastructure. Additionally, as shown in FIG. 6, the series of acts 600 includes an act 612 for implementing the machine learning pipeline file.

Further, as shown in FIG. 6, the series of acts 600 includes an act 614 for storing the machine learning pipeline file in a registry. In particular, the act 614 can include storing the machine learning pipeline file in a machine learning pipeline registry. Specifically, the act 614 can include testing the machine learning pipeline by running the machine learning pipeline file, and based on results of the test, merging the machine learning pipeline into the machine learning pipeline registry. Further, the act 614 can include based on the training of the machine learning model, identifying batch predictions and trained parameters, and storing the batch predictions and trained parameters in the machine learning pipeline registry.

Additionally, the series of acts 600 can include, based on the results of the test, identifying an existing machine learning pipeline file in the machine learning pipeline registry for update, and updating the existing machine learning pipeline file with the machine learning pipeline file. Further, the series of acts 600 can include automatically integrating the updated machine learning pipeline file into one or more implementations of the existing machine learning pipeline file.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 (e.g., the client device 110, or the server(s) 106) that may be configured to perform one or more of the processes described above. As shown by FIG. 7, the computing device can comprise a processor 702, memory 704, a storage device 706, an I/O interface 708, and a communication interface 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (“HDD”), flash memory, a Universal Serial Bus (“USB”) drive or a combination of these or other storage devices.

The computing device 700 also includes one or more input or output interface 708 (or “I/O interface 708”), which are provided to allow a user (e.g., requester or provider) to provide input to (such as user strokes), receive output from, and otherwise transfer data to and from the computing device 700. These I/O interface 708 may include a mouse, keypad or a keyboard, a touch screen, camera, optical scanner, network interface, modem, other known I/O devices or a combination of such I/O interface 708. The touch screen may be activated with a stylus or a finger.

The I/O interface 708 may include one or more devices for presenting output to a user, including, but not limited to, a graphics engine, a display (e.g., a display screen), one or more output providers (e.g., display providers), one or more audio speakers, and one or more audio providers. In certain embodiments, interface 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can comprise hardware, software, or both that connects components of computing device 700 to each other.

FIG. 8 illustrates an example network environment 800 of the inter-network facilitation system 104. The network environment 800 includes a client device 806 (e.g., client device 110), an inter-network facilitation system 104, and a third-party system 808 connected to each other by a network 804. Although FIG. 8 illustrates a particular arrangement of the client device 806, the inter-network facilitation system 104, the third-party system 808, and the network 804, this disclosure contemplates any suitable arrangement of client device 806, the inter-network facilitation system 104, the third-party system 808, and the network 804. As an example, and not by way of limitation, two or more of client device 806, the inter-network facilitation system 104, and the third-party system 808 communicate directly, bypassing network 804. As another example, two or more of client device 806, the inter-network facilitation system 104, and the third-party system 808 may be physically or logically co-located with each other in whole or in part.

Moreover, although FIG. 8 illustrates a particular number of client devices 806, inter-network facilitation systems 104, third-party systems 808, and networks 804, this disclosure contemplates any suitable number of client devices 806, inter-network facilitation system 104, third-party systems 808, and networks 804. As an example, and not by way of limitation, network environment 800 may include multiple client devices 806, inter-network facilitation system 104, third-party systems 808, and/or networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, the inter-network facilitation system 104 (which hosts the machine learning pipeline management system 102), and third-party system 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at the client device 806 to access network 804. A client device 806 may enable its user to communicate with other users at other client devices 806.

In particular embodiments, the client device 806 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 804) to link the third-party-system 808. For example, the inter-network facilitation system 104 may receive authentication credentials from a user to link a third-party system 808 such as an online bank account, credit account, debit account, or other financial account to a user account within the inter-network facilitation system 104. The inter-network facilitation system 104 can subsequently communicate with the third-party system 808 to detect or identify balances, transactions, withdrawal, transfers, deposits, credits, debits, or other transaction types associated with the third-party system 808. The inter-network facilitation system 104 can further provide the aforementioned or other financial information associated with the third-party system 808 for display via the client device 806. In some cases, the inter-network facilitation system 104 links more than one third-party system 808, receiving account information for accounts associated with each respective third-party system 808 and performing operations or transactions between the different systems via authorized network connections.

In particular embodiments, the inter-network facilitation system 104 may interface between an online banking system and a credit processing system via the network 804. For example, the inter-network facilitation system 104 can provide access to a bank account of a third-party system 808 and linked to a user account within the inter-network facilitation system 104. Indeed, the inter-network facilitation system 104 can facilitate access to, and transactions to and from, the bank account of the third-party system 808 via a client application of the inter-network facilitation system 104 on the client device 806. The inter-network facilitation system 104 can also communicate with a credit processing system, an ATM system, and/or other financial systems (e.g., via the network 804) to authorize and process credit charges to a credit account, perform ATM transactions, perform transfers (or other transactions) across accounts of different third-party systems 808, and to present corresponding information via the client device 806.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 808), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 800 either directly or via network 804. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 804.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 806. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 806 associated with users.

In addition, the third-party system 808 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 804. A third-party system 808 can communicate with the inter-network facilitation system 104 to provide financial information pertaining to balances, transactions, and other information, whereupon the inter-network facilitation system 104 can provide corresponding information for display via the client device 806. In particular embodiments, a third-party system 808 communicates with the inter-network facilitation system 104 to update account balances, transaction histories, credit usage, and other internal information of the inter-network facilitation system 104 and/or the third-party system 808 based on user interaction with the inter-network facilitation system 104 (e.g., via the client device 806). Indeed, the inter-network facilitation system 104 can synchronize information across one or more third-party systems 808 to reflect accurate account information (e.g., balances, transactions, etc.) across one or more networked systems, including instances where a transaction (e.g., a transfer) from one third-party system 808 affects another third-party system 808.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
at least one processor; and
a non-transitory computer readable medium comprising instructions that, when executed by the at least one processor, cause the system to:
receive user input defining a machine learning pipeline, the user input comprising a template machine learning model selection, ground-truth dataset selections and training parameters selections;
based on the user input, generate a machine learning pipeline file comprising instructions for:
preparing a ground-truth dataset based on the ground-truth dataset selections;
training a machine learning model based on the template machine learning model and the training parameters selections; and
defining scheduling infrastructure;
implement the machine learning pipeline file; and
store the machine learning pipeline file in a machine learning pipeline registry.

2. The system of claim 1, further comprising instructions that, when executed by the at least one processor, cause the system to generate an untrained machine learning model for training based on the template machine learning model selection, wherein the machine learning model selection comprises a template machine learning model from the machine learning pipeline registry.

3. The system of claim 1, further comprising instructions that, when executed by the at least one processor, cause the system to store the machine learning pipeline file in the machine learning pipeline registry by:
testing the machine learning pipeline by running the machine learning pipeline file; and
based on results of the test, merging the machine learning pipeline into the machine learning pipeline registry.

4. The system of claim 3, further comprising instructions that, when executed by the at least one processor, cause the system to:
based on the results of the test, identify an existing machine learning pipeline file in the machine learning pipeline registry for update; and
update the existing machine learning pipeline file with the machine learning pipeline file.

5. The system of claim 4, further comprising instructions that, when executed by the at least one processor, cause the system to automatically integrate the updated machine learning pipeline file into one or more implementations of the existing machine learning pipeline file.

6. The system of claim 1, further comprising instructions that, when executed by the at least one processor, cause the system to generate a machine learning pipeline graphical user interface for viewing, tracking, and managing the machine learning pipeline.

7. The system of claim 1, further comprising instructions that, when executed by the at least one processor, cause the system to:
based on the training of the machine learning model, identify batch predictions and trained parameters; and
store the batch predictions and trained parameters in the machine learning pipeline registry.

8. A method comprising:
receiving user input defining a machine learning pipeline, the user input comprising a template machine learning model selection, ground-truth dataset selections and training parameters selections;
based on the user input, generating a machine learning pipeline file comprising instructions for:
preparing a ground-truth dataset based on the ground-truth dataset selections;
training a machine learning model based on the template machine learning model and the training parameters selections; and
defining scheduling infrastructure;
implementing the machine learning pipeline file; and
storing the machine learning pipeline file in a machine learning pipeline registry.

9. The method of claim 8, further comprising generating an untrained machine learning model for training based on the template machine learning model selection, wherein the machine learning model selection comprises a template machine learning model from the machine learning pipeline registry.

10. The method of claim 8, further comprising storing the machine learning pipeline file in the machine learning pipeline registry by:
testing the machine learning pipeline by running the machine learning pipeline file; and
based on results of the test, merging the machine learning pipeline into the machine learning pipeline registry.

11. The method of claim 10, further comprising:
based on the results of the test, identifying an existing machine learning pipeline file in the machine learning pipeline registry for update; and
updating the existing machine learning pipeline file with the machine learning pipeline file.

12. The method of claim 11, further comprising automatically integrating the updated machine learning pipeline file into one or more implementations of the existing machine learning pipeline file.

13. The method of claim 8, further comprising generating a machine learning pipeline graphical user interface for viewing, tracking, and managing the machine learning pipeline.

14. The method of claim 8, further comprising:
based on the training of the machine learning model, identifying batch predictions and trained parameters; and
storing the batch predictions and trained parameters in the machine learning pipeline registry.

15. A non-transitory computer readable medium comprising instructions that, when executed by at least one processor, cause a computing device to:
receive user input defining a machine learning pipeline, the user input comprising a template machine learning model selection, ground-truth dataset selections and training parameters selections;
based on the user input, generate a machine learning pipeline file comprising instructions for:
preparing a ground-truth dataset based on the ground-truth dataset selections;
training a machine learning model based on the template machine learning model and the training parameters selections; and
defining scheduling infrastructure;
implement the machine learning pipeline file; and
store the machine learning pipeline file in a machine learning pipeline registry.

16. The non-transitory computer readable medium of claim 15, further comprising instructions that, when executed by the at least one processor, cause the computing device to generate an untrained machine learning model for training based on the template machine learning model selection, wherein the machine learning model selection comprises a template machine learning model from the machine learning pipeline registry.

17. The non-transitory computer readable medium of claim 15, further comprising instructions that, when executed by the at least one processor, cause the computing device to:
store the machine learning pipeline file in the machine learning pipeline registry by:
testing the machine learning pipeline by running the machine learning pipeline file; and
based on results of the test, merging the machine learning pipeline into the machine learning pipeline registry.

18. The non-transitory computer readable medium of claim 17, further comprising instructions that, when executed by the at least one processor, cause the computing device to:
based on the results of the test, identify an existing machine learning pipeline file in the machine learning pipeline registry for update;
update the existing machine learning pipeline file with the machine learning pipeline file; and
automatically integrate the updated machine learning pipeline file into one or more implementations of the existing machine learning pipeline file.

19. The non-transitory computer readable medium of claim 15, further comprising instructions that, when executed by the at least one processor, cause the computing device to generate a machine learning pipeline graphical user interface for viewing, tracking, and managing the machine learning pipeline.

20. The non-transitory computer readable medium of claim 15, further comprising instructions that, when executed by the at least one processor, cause the computing device to:
based on the training of the machine learning model, identify batch predictions and trained parameters; and
store the batch predictions and trained parameters in the machine learning pipeline registry.
